(19) United States
(12) Patent Application Publication
(10) Pub. No.: US 2025/0306815 A1
(43) Pub. Date: Oct. 2, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Shinya MIYAMORI, Kanagawa (JP)

(73) Assignee: FUJIFILM Business Innovation Corp., Tokyo (JP)

(21) Appl. No.: 18/822,308

(22) Filed: Sep. 2, 2024

(30) Foreign Application Priority Data
Mar. 26, 2024 (JP) 2024-050344

(51) Int. Cl. G06F 3/12

(52) U.S. Cl. CPC G06F 3/121; G06F 3/1207; G06F 3/1234

(57) ABSTRACT

An information processing system includes: a processor configured to: acquire fault information that is information on a fault occurring in an image formed by an image forming apparatus; and specify a print job which is executable by the image forming apparatus and with which the fault does not occur or a degree of the fault is reduced, based on the acquired fault information.

### CROSS-REFERENCE TO RELATED APPLICATIONS

This application is based on and claims priority under 35 USC 119 from Japanese Patent Application No. 2024-050344 filed Mar. 26, 2024.

### BACKGROUND

### (i) Technical Field

The present invention relates to an information processing system, a non-transitory computer readable medium storing a program, and an information processing method.

### (ii) Related Art

JP2013-219413A discloses an image forming system including a notification section that notifies, in the case where a failure of a function of an image forming apparatus is detected, of the failure situation, and a setting section capable of selecting and setting a level of the function that is not available depending on a type of the failure from among a plurality of levels.

JP2019-174758A discloses a failure diagnosis apparatus that detects a failure location, which is a constituent component in which an abnormality occurs among constituent components of an image forming apparatus, from image data obtained by scanning an image formed by the image forming apparatus.

### SUMMARY

In a case of forming an image on a recording medium, an image forming apparatus may be used to form the image on the recording medium.

Here, in a situation in which a fault occurs in the image formed by the image forming apparatus, a situation may occur in which the image forming apparatus cannot form an image and the image forming apparatus cannot be used.

Aspects of non-limiting embodiments of the present disclosure relate to an information processing system, a non-transitory computer readable medium storing a program, and an information processing method that form, even in cases where a fault occurs in an image formed by an image forming apparatus, an image in which the fault does not occur or the degree of the fault is minimized, by using the image forming apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: acquire fault information that is information on a fault occurring in an image formed by an image forming apparatus; and specify a print job which is executable by the image forming apparatus and with which the fault does not occur or a degree of the fault is reduced, based on the acquired fault information.

### BRIEF DESCRIPTION OF THE DRAWINGS

Exemplary embodiment(s) of the present invention will be described in detail based on the following figures, wherein:

FIG. 1 is a diagram illustrating an example of a diagnosis system;

FIG. 2 is a diagram illustrating a configuration example of hardware of a server apparatus and an information processing unit provided in an image forming apparatus;

FIG. 3 is a diagram describing the image forming apparatus;

FIG. 4 is a diagram describing a process executed in relation to specifying and a proposal of a proposal print job;

FIG. 5 is a diagram illustrating another example of a screen generated by a CPU of the server apparatus;

FIG. 6 is a diagram describing a cause of an image fault;

FIG. 7 is a diagram illustrating still another example of the screen generated by the CPU of the server apparatus;

FIG. 8 is a diagram illustrating the screen generated by the CPU of the server apparatus;

FIG. 9 is a diagram illustrating a screen displayed on a user terminal;

FIG. 10 is a diagram illustrating the screen generated by the server apparatus;

FIG. 11 is a diagram illustrating a reception screen generated by the CPU of the server apparatus; and

FIG. 12 is a diagram illustrating a screen referred to by a user of the image forming apparatus.

### DETAILED DESCRIPTION

Hereinafter, an exemplary embodiment of the present disclosure will be described with reference to the accompanying drawings.

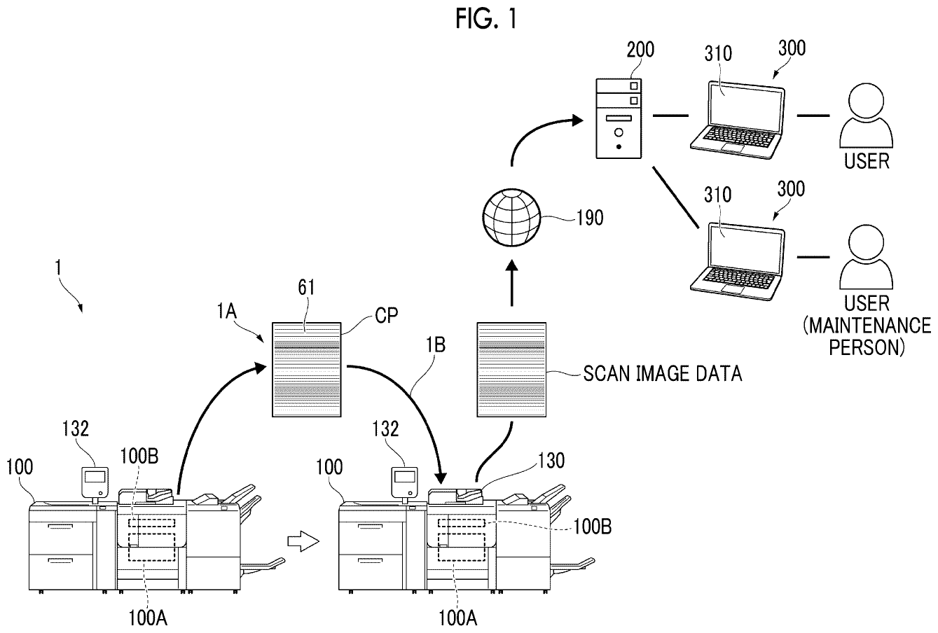

FIG. 1 is a diagram illustrating an example of a diagnosis system 1.

The diagnosis system 1 according to the present exemplary embodiment is provided with a plurality of image forming apparatuses 100 and a server apparatus 200 that is connected to each of the plurality of image forming apparatuses 100 via a communication line 190.

In FIG. 1, two image forming apparatuses 100 among the plurality of image forming apparatuses 100 are displayed.

In the present exemplary embodiment, in the server apparatus 200 as an example of an information processing system, diagnosis of each image forming apparatus 100 is performed.

The diagnosis system 1 further includes a user terminal 300. The user terminal 300 is connected to the server apparatus 200. The user terminal 300 receives an operation from a user.

In the present exemplary embodiment, the user terminal 300 is provided in a manner corresponding to each of a plurality of users, and a plurality of user terminals 300 are provided.

Examples of the user include a user of the image forming apparatus 100 or a maintenance person of the image forming apparatus 100. In the present exemplary embodiment, the user terminal 300 that is referred to by the user or the maintenance person is provided.

The user terminal 300 is provided with a display device 310. The user terminal 300 is realized by a computer. Examples of a form of the user terminal 300 include a personal computer (PC), a smartphone, and a tablet terminal.

The image forming apparatus 100 is provided with a forming function unit 100A as an example of an image forming section that forms an image on paper which is an example of a recording medium.

The image forming apparatus 100 is further provided with an information processing unit 100B. The information processing unit 100B executes various processes executed in the image forming apparatus 100.

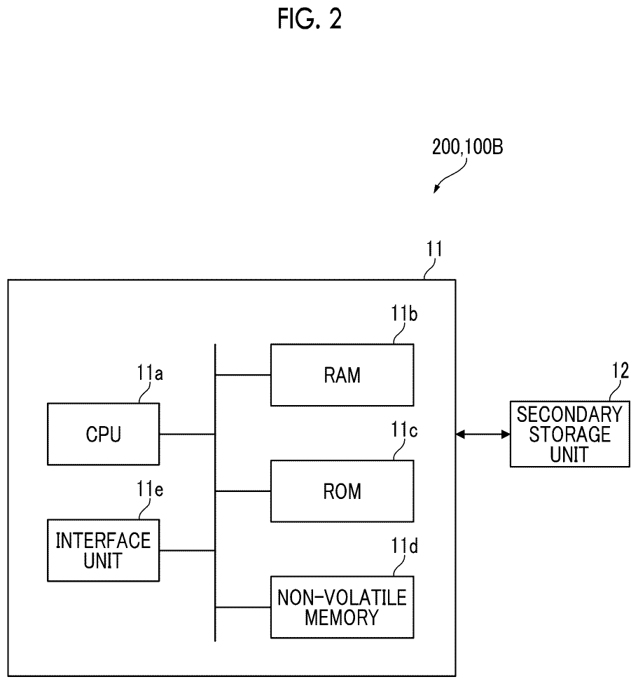

FIG. 2 is a diagram illustrating a configuration example of hardware of the server apparatus 200 and the information processing unit 100B provided in the image forming apparatus 100. The server apparatus 200 and the information processing unit 100B provided in the image forming apparatus 100 are realized by a computer.

Each of the server apparatus 200 and the information processing unit 100B includes an arithmetic processing unit 11 that executes a digital arithmetic process according to a program, and a secondary storage unit 12 that stores information.

The secondary storage unit 12 is realized, for example, by a known information storage device such as a hard disk drive (HDD), a semiconductor memory, or a magnetic tape.

The arithmetic processing unit 11 is provided with a CPU 11a as an example of a processor.

In addition, the arithmetic processing unit 11 is provided with a RAM 11b used as a working memory or the like of the CPU 11a and a ROM 11c in which programs or the like executed by the CPU 11a are stored.

In addition, the arithmetic processing unit 11 is provided with a non-volatile memory 11d that is configured to be rewritable and can hold data even in a case where power supply is interrupted and an interface unit 11e that controls each unit, such as a communication unit, connected to the arithmetic processing unit 11.

The non-volatile memory 11d is configured with, for example, an SRAM or a flash memory that is backed up by a battery. The secondary storage unit 12 stores the programs executed by the arithmetic processing unit 11 in addition to files and the like.

In the present exemplary embodiment, the CPU 11a reads the program stored in the ROM 11c or the secondary storage unit 12 to execute each process.

The program executed by the CPU 11a can be provided to the server apparatus 200 and the information processing unit 100B in a state in which the program is stored in a computer-readable recording medium such as a magnetic recording medium (for example, a magnetic tape or a magnetic disk), an optical recording medium (for example, an optical disk), a magneto-optical recording medium, or a semiconductor memory. Further, the program executed by the CPU 11a may be provided to the server apparatus 200 and the information processing unit 100B by a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The process executed by the image forming apparatus 100 among the processes described below is executed by the CPU 11a as an example of the processor provided in the image forming apparatus 100. The process executed by the server apparatus 200 among the processes described below is executed by the CPU 11a as an example of the processor provided in the server apparatus 200.

Further, the process related to diagnosis on the image forming apparatus 100 among the processes described below is executed by the server apparatus 200 as an example of an information processing system. The information processing system that performs the process related to the diagnosis on the image forming apparatus 100 may be realized by one apparatus such as one server apparatus 200 or may be realized by a plurality of apparatuses.

The “information processing system” in the present exemplary embodiment is configured with a single apparatus as an example, and may be configured with a plurality of apparatuses.

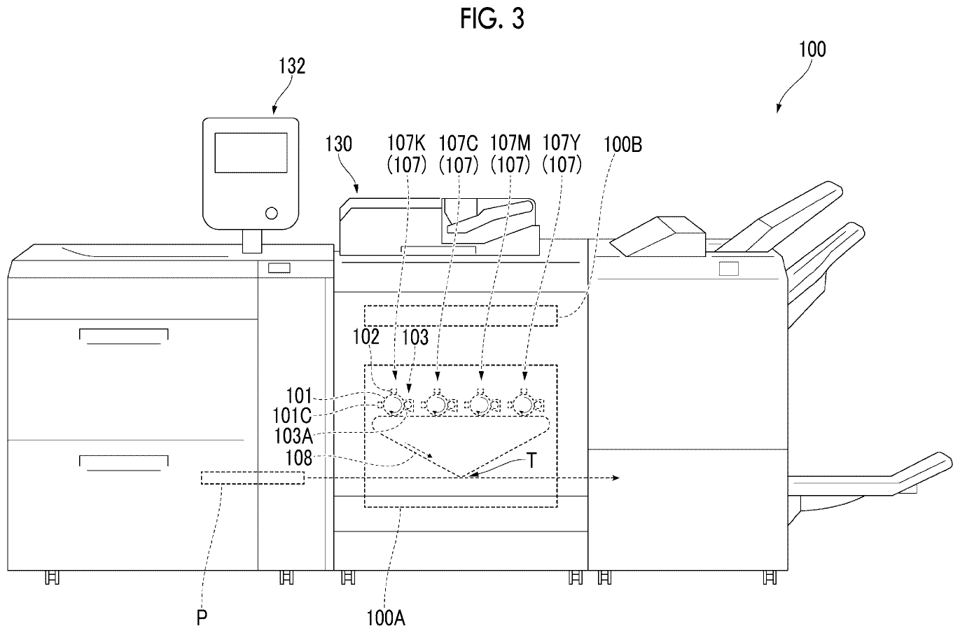

FIG. 3 is a diagram describing the image forming apparatus 100.

In the present exemplary embodiment, as described above, the image forming apparatus 100 is provided with the forming function unit 100A that forms an image on paper P which is an example of a recording medium. An electrophotographic method is used for forming the image on the paper P by the forming function unit 100A.

The forming function unit 100A is provided with an intermediate transfer belt 108 as a member that moves in a circumferential direction and a plurality of image forming units 107 that form images in colors different from each other.

In the present exemplary embodiment, the image formed by each of the plurality of image forming units 107 is temporarily transferred to the intermediate transfer belt 108, and then transferred to the paper P.

The plurality of image forming units 107 form the images in colors different from each other on the intermediate transfer belt 108. The intermediate transfer belt 108 may not be provided, and a configuration in which the image is directly transferred to the paper P from each of the plurality of image forming units 107 may be adopted.

In addition, the plurality of image forming units 107 may not be provided, and a configuration in which only one image forming unit 107 is provided may be adopted. In a case of the configuration in which only one image forming unit 107 is provided, the intermediate transfer belt 108 is omitted.

In the present exemplary embodiment, as the image forming unit 107, an image forming unit 107Y that forms an image of Yellow, an image forming unit 107M that forms an image of Magenta, an image forming unit 107C that forms an image of Cyan, and an image forming unit 107K that forms an image of Black are provided.

The image formed by each of the image forming units 107 is transferred to the intermediate transfer belt 108 as an example of a transfer member. Thereafter, at a transfer unit T, this image is transferred to the paper P, which is transported to the transfer unit T. Therefore, an image is formed on the paper P.

A photosensitive drum 101 as an example of an image holding body is provided in each of the image forming units 107. The photosensitive drum 101 is rotated in a clockwise direction.

Further, in each of the image forming units 107, a charging device 101C that performs charging on the photosensitive drum 101 and an exposure device 102 that performs exposing on the photosensitive drum 101 are provided.

Further, a developing device 103 that performs development on an electrostatic latent image formed on the photosensitive drum 101 by the exposure by the exposure device 102 is provided in each of the image forming units 107.

The developing device 103 is provided with a developing roll 103A disposed at a position facing the photosensitive drum 101. In the present exemplary embodiment, development is performed by a developer adhering to an outer peripheral surface of the developing roll 103A moving to a surface of the photosensitive drum 101.

In a case where the development is performed, an image by, for example, a toner is formed on the photosensitive drum 101. Thereafter, this image is transferred to an outer circumferential surface of the intermediate transfer belt 108. Thereafter, in the present exemplary embodiment, this image on the intermediate transfer belt 108 is transferred to the paper P, and the image is formed on the paper P.

The formation of the image on the paper P by the forming function unit 100A is not limited to the electrophotographic method, and other methods such as an ink jet method may be used.

The image forming apparatus 100 is further provided with an image scanning device 130. In addition, the image forming apparatus 100 has an information transmission function to transmit information to the server apparatus 200 (see FIG. 1).

This image scanning device 130 as an example of an image scanning section is a so-called scanner that scans an image formed on paper (not illustrated) as an example of a recording medium.

The image scanning device 130 includes a light source that emits light with which paper is to be irradiated and a light receiving unit such as a CCD that receives reflected light from the paper. In the present exemplary embodiment, scan image data described below is generated based on the reflected light received by the light receiving unit.

The image scanning device 130 according to the present exemplary embodiment has a function of transporting paper.

A scanning position of an image is set in advance in the image scanning device 130, and the image scanning device 130 scans an image at a portion of paper that is sequentially transported, which is located at the scanning position.

In the example illustrated in FIG. 3, the image scanning device 130 is provided at an upper portion of the image forming apparatus 100. The image scanning device 130 sequentially scans the paper set by the user.

An installation mode of the image scanning device 130 is not limited to the mode illustrated in FIG. 3. The image scanning device 130 may be provided inside the image forming apparatus 100 and on a transport path of the paper P.

In this case, the paper P on which an image is formed by the forming function unit 100A sequentially passes through the image scanning device 130, and at the time of passing through the paper P, each image of the paper P is scanned in order.

In the present exemplary embodiment, the image scanning device 130 is provided with a reversing mechanism of the paper P such that the paper P can be supplied after the front and back sides are reversed with respect to the scanning position of the image.

Therefore, in the present exemplary embodiment, the scanned paper P on which the image is formed on one surface is reversed and can be supplied to the scanning position again. Therefore, the image on the front surface and the image on the back surface of the paper P can be scanned.

In addition, in scanning an image on the paper P, the paper P may be placed on a document stand (not illustrated) configured with plate-shaped glass or the like such that the paper P placed on the document stand may be scanned.

Further, an operation reception unit 132 that receives an operation from a user who uses the image forming apparatus 100 is provided in each of the image forming apparatuses 100.

The operation reception unit 132 is configured with a so-called touch panel. The operation reception unit 132 displays information to the user, and receives the operation performed by the user.

The display of the information to the user and the reception of the operation of the user are not limited to being performed by one operation reception unit 132 as in the present exemplary embodiment, and the operation reception unit 132 and an information display unit may be individually provided.

In the present exemplary embodiment, in a case where the image forming apparatus 100 (see FIG. 1) is diagnosed, first, the forming function unit 100A is operated to form a diagnosis image 61 on the paper P. Therefore, as indicated by a reference numeral 1A, diagnosis paper CP which is the paper P on which the diagnosis image 61 is formed is generated.

The diagnosis image 61 is an image to be used to diagnose the image forming apparatus 100. In the present exemplary embodiment, the diagnosis paper CP which is the paper P on which the diagnosis image 61 to be used for the diagnosis is formed is generated.

In a case where the diagnosis paper CP is generated, as indicated by a reference numeral 1B in FIG. 1, the diagnosis paper CP is placed in the image scanning device 130. The image scanning device 130 is used to scan the diagnosis paper CP on which the diagnosis image 61 is formed.

Therefore, scan image data obtained by scanning the diagnosis paper CP is generated.

In the present exemplary embodiment, the scan image data is transmitted to the server apparatus 200, and then is stored in the server apparatus 200. The server apparatus 200 diagnoses the image forming apparatus 100 based on the scan image data.

In the present exemplary embodiment, the user or the maintenance person of the image forming apparatus 100 accesses the server apparatus 200 via the user terminal 300, and refers to a result of the diagnosis by the server apparatus 200.

In each of the image forming apparatuses 100, the diagnosis paper CP is generated in this manner, and the diagnosis paper CP is scanned to generate scan image data.

Such scan image data is transmitted to the server apparatus 200.

Next, as described above, in the present exemplary embodiment, the server apparatus 200 diagnoses the image forming apparatus 100. Thereafter, the user or the maintenance person of the image forming apparatus 100 refers to the result of the diagnosis.

### Diagnosis Process by Server Apparatus

A diagnosis process executed by the server apparatus 200 will be described.

In the present exemplary embodiment, first, the CPU 11a (see FIG. 2) as an example of the processor provided in the server apparatus 200 (see FIG. 1) diagnoses the image forming apparatus 100 based on the scan image data described above, which is transmitted from the image forming apparatus 100, and then acquires a diagnosis result.

More specifically, the CPU 11a analyzes the diagnosis image 61 that is an image formed on the diagnosis paper CP to acquire a diagnosis result.

In a case where a fault occurs in the diagnosis image 61 formed on the diagnosis paper CP, the CPU 11a of the server apparatus 200 acquires fault information, which is information on the fault occurring in the diagnosis image 61 formed by the image forming apparatus 100.

More specifically, the CPU 11a of the server apparatus 200 acquires, as the fault information, information on the fault, such as a content of the fault, and information on a member that causes the fault, which is obtained based on the information on the fault.

The CPU 11a of the server apparatus 200 specifies a print job which is executable by the image forming apparatus 100 and with which a fault occurring in the diagnosis image 61 described above does not occur or the degree of the fault is reduced, based on the acquired fault information.

The CPU 11a of the server apparatus 200 generates a screen (to be described below) that includes information on the specified print job. Next, the CPU 11a of the server apparatus 200 causes the user terminal 300 of the user of the image forming apparatus 100 or the like to display the generated screen.

Therefore, the user of the image forming apparatus 100 is notified of information on the specified print job via this screen.

In the present exemplary embodiment, the CPU 11a of the server apparatus 200 acquires the fault information described above, which is obtained by analyzing the diagnosis image 61 described above, which is an example of the image actually formed by the image forming apparatus 100.

The CPU 11a of the server apparatus 200 specifies a print job which is notified to the user of the image forming apparatus 100 based on the acquired fault information and with which the fault occurring in the diagnosis image 61 does not occur or the degree of the fault is reduced.

The CPU 11a of the server apparatus 200 acquires a diagnosis result obtained by analyzing the diagnosis image 61 described above, which is an example of the image actually formed by the image forming apparatus 100. The analysis of the diagnosis image 61 may be performed by the CPU 11a of the server apparatus 200 or by another apparatus other than the server apparatus 200.

In any case, in the present exemplary embodiment, the CPU 11a of the server apparatus 200 acquires the diagnosis result obtained by analyzing the diagnosis image 61.

The CPU 11a of the server apparatus 200 specifies a print job with which the fault occurring in the diagnosis image 61 formed by the image forming apparatus 100 does not occur or the degree of the fault is reduced, based on the acquired diagnosis result.

In the present exemplary embodiment, the fault information and the information on the print job presented to the user of the image forming apparatus 100 are stored in the secondary storage unit 12 (see FIG. 2) of the server apparatus 200 in association with each other.

In other words, in the present exemplary embodiment, the fault information and the information on the print job proposed to the user of the image forming apparatus 100 are stored in the secondary storage unit 12 of the server apparatus 200 in association with each other.

The CPU 11a of the server apparatus 200 reads out the print job associated with the acquired fault information from the secondary storage unit 12.

The CPU 11a of the server apparatus 200 specifies the read-out print job as a print job with which a fault does not occur or the degree of the fault is reduced.

Thereafter, the CPU 11a of the server apparatus 200 notifies the user of the image forming apparatus 100 of the specified print job.

The present exemplary embodiment has a manner in which this print job, which is specified by the CPU 11a of the server apparatus 200 and with which a fault does not occur or the degree of the fault is reduced, is presented to the user of the image forming apparatus 100. In the present exemplary embodiment, the print job specified by the CPU 11a of the server apparatus 200 is referred to as a “proposal print job” hereinafter.

### Specifying of Proposal Print Job

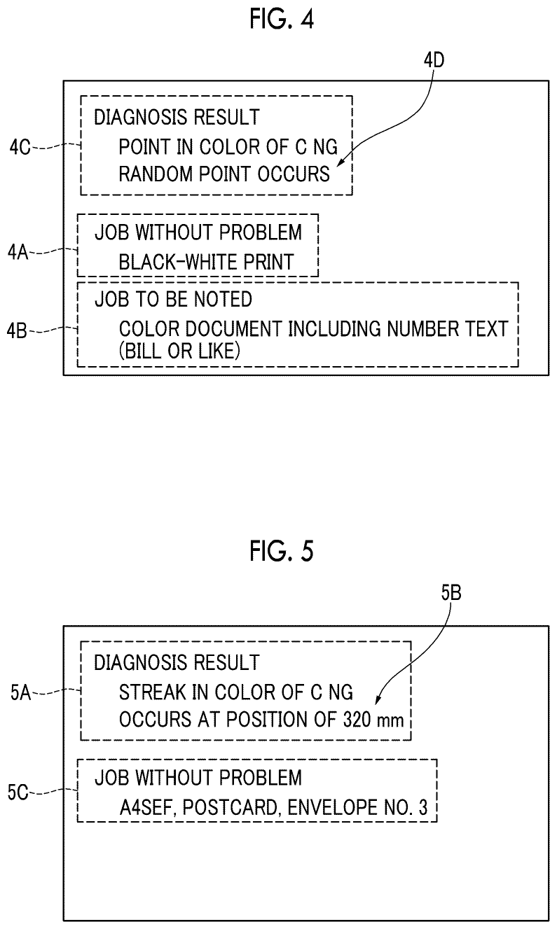

FIG. 4 is a diagram describing a process executed in relation to specifying and a proposal of a proposal print job.

After specifying the proposal print job, the CPU 11a of the server apparatus 200 generates, for example, a screen illustrated in FIG. 4.

This screen generated by the CPU 11a of the server apparatus 200 is transmitted to, for example, the user terminal 300 (see FIG. 1) of a user of the image forming apparatus 100, and is displayed on the user terminal 300. Therefore, the user of the image forming apparatus 100 refers to this screen.

This screen may also be displayed on the operation reception unit 132 provided in the image forming apparatus 100.

In this screen illustrated in FIG. 4, a proposal print job specified by the CPU 11a of the server apparatus 200 is included as illustrated by reference numerals 4A and 4B. In the present exemplary embodiment, the proposal print job is notified to the user of the image forming apparatus 100 via this screen.

In this example, as indicated by the reference numeral 4A, one proposal print job is black-and-white printing.

In the present exemplary embodiment, this black-white printing is notified to the user of the image forming apparatus 100 as the proposal print job via the screen illustrated in FIG. 4.

The CPU 11a of the server apparatus 200 specifies the black-white printing based on the acquired fault information. In the screen illustrated in FIG. 4, fault information specified by the CPU 11a of the server apparatus 200 is also included, as indicated by a reference numeral 4C.

In this example, as the fault information, the image forming unit 107C provided corresponding to cyan among the plurality of provided image forming units 107 (see FIG. 3) is specified and displayed.

In FIG. 4, the image forming unit 107C provided corresponding to cyan is represented as “color of C”.

In this example, the CPU 11a of the server apparatus 200 specifies the image forming unit 107C, which is one of some image forming units among the plurality of provided image forming units 107 and is provided corresponds to cyan, as a member that causes the fault.

In the present exemplary embodiment, information on the image forming unit 107C provided corresponding to cyan is included in the screen illustrated in FIG. 4 as the fault information.

Further, in this example, as illustrated by a reference numeral 4D, information indicating that random points occur in the diagnosis image 61 is displayed as the fault information.

In this example, the CPU 11a of the server apparatus 200 specifies the random points as a specific fault occurring in the diagnosis image 61. Accordingly, in the present exemplary embodiment, information on the random points is included in the screen illustrated in FIG. 4.

In this example, as illustrated by the reference numeral 4A, the CPU 11a of the server apparatus 200 specifies a black-white print job, which is a print job that does not use the image forming unit 107C provided for cyan, as the proposal print job.

In other words, in this case, the CPU 11a of the server apparatus 200 specifies a print job with which the member causing the fault is not used, as the proposal print job.

In other words, the CPU 11a of the server apparatus 200 specifies a print job with which the some image forming units 107 among the plurality of provided image forming units 107 are not used, as the proposal print job.

In this case, in a case where image formation based on this proposal print job is performed by the image forming apparatus 100, the image fault that occurs in the diagnosis image 61 does not occur in an image formed based on this proposal print job.

Specifically, the point image fault caused by the image forming unit 107C provided corresponding to cyan does not occur.

In the present exemplary embodiment, in a case where a print job is a black-white print job, the photosensitive drums 101 of yellow, magenta, and cyan (see FIG. 3) are configured to automatically separate from the intermediate transfer belt 108.

In the present exemplary embodiment, a separation mechanism (not illustrated) that separates the photosensitive drums 101 of yellow, magenta, and cyan from the intermediate transfer belt 108 is provided.

In the present exemplary embodiment, in a case where a print job input to the image forming apparatus 100 is a black-white print job, the separation mechanism is operated, and the photosensitive drums 101 of yellow, magenta, and cyan are separated from the intermediate transfer belt 108.

In this case, in a case where the user of the image forming apparatus 100 executes the black-white print job, which is a proposal print job, an image formed by the black-white printing does not have an image fault caused by the image forming unit 107C of cyan occurring in the diagnosis image 61.

In the present exemplary embodiment, even in a case where an image fault occurs in an image formed by using the image forming unit 107C of cyan, this image fault does not occur in a case where a black-white print job is executed.

In a case where an image fault occurs in an image formed by the image forming apparatus 100, it is possible to resolve the image fault by calling a maintenance person, such as a service engineer. Meanwhile, a case is also assumed in which the maintenance person may not immediately go to an installation location of the image forming apparatus 100.

In the configuration of the present exemplary embodiment, in this case, by executing the black-white print job, the image forming apparatus 100 can be continuously used even in a situation in which the maintenance person has not yet arrived.

In addition, for each of the plurality of provided photosensitive drums 101, an aspect in which the photosensitive drum 101 is individually separated from the intermediate transfer belt 108 may be considered.

In this case, as described above, in a case where an image fault caused by the image forming unit 107C provided corresponding to cyan occurs, for example, as the print job, not only the black-white print job described above but also a “print job using a color other than cyan” may be proposed.

Also in this case, by executing a print job using a color other than cyan, it is possible to continue using the image forming apparatus 100 even in a situation in which the maintenance person has not yet arrived.

FIG. 5 is a diagram illustrating another example of the screen generated by the CPU 11a of the server apparatus 200.

In this example, as indicated by a reference numeral 5A, an image fault occurring in the diagnosis image 61 is a streak-like image fault. In addition, in this example, in the same manner as in the above, a cause of the image fault is the image forming unit 107C provided corresponding to cyan.

Further, in this example, as indicated by a reference numeral 5B, the CPU 11a of the server apparatus 200 also acquires position information, which is information on a position of the fault occurring in the diagnosis image 61, as fault information. This screen illustrated in FIG. 5 includes the position information acquired by the CPU 11a of the server apparatus 200.

In this example, the CPU 11a of the server apparatus 200 acquires, as the position information of the fault, position information indicating that a position at which the streak-like image fault occurs in the diagnosis image 61 is 320 mm.

In the present exemplary embodiment, this position information is included in the screen illustrated in FIG. 5.

Here, the position information of the image fault occurring in the diagnosis image 61 is included in the screen referred to by the user of the image forming apparatus 100.

Further, in this example, in the same manner as in the above, information on the image forming unit 107C provided corresponding to cyan is displayed with “color of C” as the fault information.

In this example, in the same manner as in the above, the CPU 11a of the server apparatus 200 acquires, as the fault information, information indicating that the image fault is caused by the image forming unit 107C provided corresponding to cyan.

In other words, the CPU 11a of the server apparatus 200 acquires, as the fault information, information indicating that a member causing the image fault is the image forming unit 107C provided corresponding to cyan.

In this process example, not only the information on the image forming unit 107C provided corresponding to cyan, which is an example of a member causing a fault, but also the information on the location causing the fault is acquired as described above.

More specifically, as the information on the location causing the fault, position information on a position of the location causing the fault is also acquired.

Specifically, in this example, the position information indicating the position of the location at which the fault occurs, that is, 320 mm, is acquired as the information on the location causing the fault.

Further, on the screen illustrated in FIG. 5, the proposal print job is displayed in the same manner as in the above, as indicated by a reference numeral 5C. In this process example as well, the CPU 11a of the server apparatus 200 specifies the proposal print job based on the acquired fault information.

In this example, the CPU 11a of the server apparatus 200 specifies a print job with which a member causing the fault is to be continuously used as the proposal print job.

More specifically, in this example, the CPU 11a of the server apparatus 200 continues to use the member causing the fault as it is, and specifies a print job with which a location other than the location causing the fault in the member is to be used as the proposal print job.

Here, the “member causing the fault” is the image forming unit 107C provided corresponding to cyan. In addition, the “location causing the fault” is a location specified by the position information of 320 mm described above.

In this process example, the CPU 11a of the server apparatus 200 specifies a print job, which is a print job with which the image forming unit 107C provided corresponding to cyan as the member causing the fault is to be used and a location other than the location specified by the position information of 320 mm described above in the image forming unit 107C is to be used, as the proposal print job.

Specifically, in this example, the CPU 11a of the server apparatus 200 specifies print jobs for A4SEF, postcard, and envelope No. 3, as the proposal print jobs as indicated by the reference numeral 5C.

The “A4SEF” refers to a print job using the paper P of A4-size, in which the paper P is transported with a short side of the paper P as a head.

The CPU 11a of the server apparatus 200 includes information on the specified proposal print job in the screen illustrated in FIG. 5.

In the present exemplary embodiment, the screen illustrated in FIG. 5 is displayed on the user terminal 300, which is referred to by the user of the image forming apparatus 100, and the user of the image forming apparatus 100 refers to this screen.

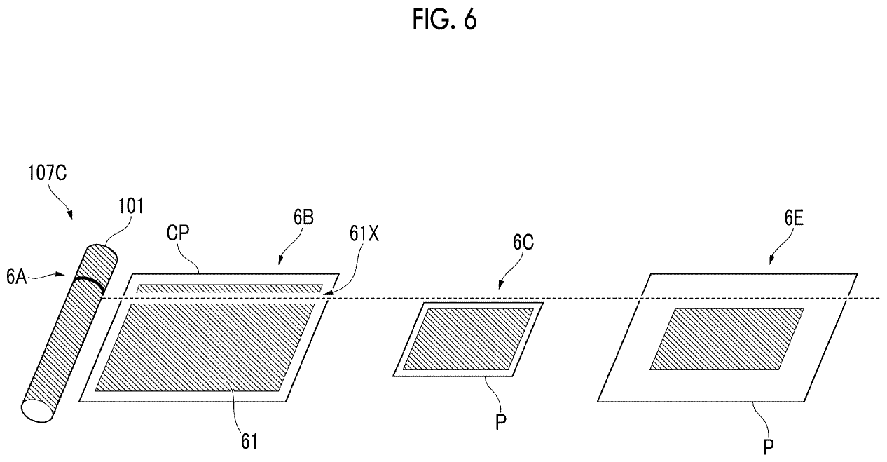

FIG. 6 is a diagram describing a cause of an image fault.

FIG. 6 illustrates a relationship between the photosensitive drum 101 of cyan and the diagnosis paper CP. In addition, in FIG. 6, a location specified by position information of 320 mm is indicated by a reference numeral 6A in FIG. 6. The location indicated by the reference numeral 6A is located at an end portion of the photosensitive drum 101.

In this example, a scratch occurs at the end portion of the photosensitive drum 101. In other words, in this example, a scratch occurs at a location causing a fault of the image forming unit 107C of cyan.

Further, as illustrated by a reference numeral 6B in FIG. 6, an image fault 61X on the diagnosis image 61 caused by the scratch is also displayed.

In the present exemplary embodiment, in a situation in which such image faults occur, as described above, print jobs such as A4SEF, postcard, and envelope No. 3 are specified as proposal print jobs.

In this case, as illustrated by a reference numeral 6C, a location of the photosensitive drum 101, which does not have a scratch, is used to form an image on the paper P.

In this case, in a case where printing is performed based on the proposal print job, an image fault does not occur in the image formed based on the proposal print job.

In this manner, in a case where the print job of A4SEF, postcard, envelope No. 3, or the like is specified as the proposal print job, an image fault does not occur.

In addition, the specifying of the proposal print job is not limited to specifying of the proposal print job with which an image fault does not occur, and a print job with which the degree of the fault is reduced may also be specified as the proposal print job.

For example, a case is assumed in which an image fault occurs due to a plurality of locations of the image forming unit 107C of cyan.

In this case, in the image forming unit 107C of cyan, a print job with which a location at which the occurring fault is large is not to be used and a location at which the occurring fault is small is to be used may be specified as the proposal print job.

In this case, in a case where the specified proposal print job is executed, a fault occurs in an image formed based on this proposal print job, and the degree of the fault is reduced.

In addition, in the specifying of the proposal print job, a proposal print job having a form in which a forming position of an image is specifically specified may be specified.

For example, a display such as “printing can be performed in a case of a print job for forming an image within a range of XX to XX” may be made on the user terminal 300 referred to by a user.

In other words, the user may be notified of the proposal print job with which the forming position of the image is specifically specified.

In this case, as illustrated by a reference numeral 6E in FIG. 6, a location of the photosensitive drum 101, at which no scratch occurs, is used to form an image on the paper P. In this case, no image fault occurs in the image formed based on this proposal print job.

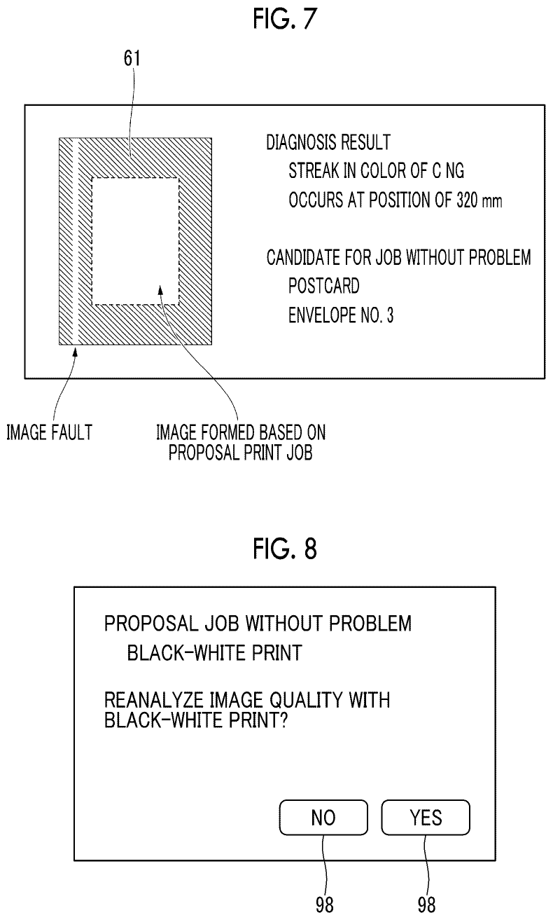

FIG. 7 is a diagram illustrating still another example of a screen generated by the CPU 11a of the server apparatus 200.

On this screen illustrated in FIG. 7, an image illustrating a positional relationship between an image fault occurring in the diagnosis image 61 and an image formed based on a proposal print job is additionally displayed.

In notifying the user of the image forming apparatus 100 of the proposal print job, the image forming apparatus 100 may include an image illustrating the positional relationship between the image fault occurring in the diagnosis image 61 and the image formed based on the proposal print job.

In the proposal print job with which a location causing the fault in the image forming unit 107C is not used, as illustrated in FIG. 7, the image formed by the proposal print job is positioned at a location shifted from a position at which the image fault occurs.

In a case where the user of the image forming apparatus 100 refers to the screen displayed in FIG. 7, the user recognizes that no image fault occurs in the image formed based on the proposal print job.

The description will be further made with reference to FIG. 4 again.

In the example illustrated in FIG. 4, as indicated by the reference numeral 4B, the CPU 11a of the server apparatus 200 also displays a print job without a number text, as a proposal print job.

More specifically, the CPU 11a of the server apparatus 200 further includes a black-white print job without a number text, in the screen illustrated in FIG. 4, as the proposal print job.

In the example illustrated in FIG. 4, a print job for a color document including a number text is displayed as a print job to be avoided. With this display, in this example, in practice, a black-white print job without a number text is displayed as the proposal print job.

In other words, in the example illustrated in FIG. 4, by listing the print job for the color document including the number text as a print job to be noted, the print job without the number text is displayed as the proposal print job in practice.

In other words, in the example illustrated in FIG. 4, for example, the print job for the color document including the number text is described as a print job that is likely to cause a fault and is not preferable, and thus the print job without the number text is displayed as the proposal print job in practice.

Examples of the print job including the number text are print jobs for a bill or a form.

Examples of the print job without the number text are print jobs other than the print job for the bill or the form.

In addition, on the screen illustrated in FIG. 4, as indicated by the reference numeral 4D, information on a fault in which a point-like image appears irregularly is displayed as fault information.

In the present exemplary embodiment, the CPU 11a of the server apparatus 200 lists the print job without the number text as the proposal print job with which the fault does not occur or is unlikely to occur, as described above.

In a case where the print job including the number text is executed under a situation in which an image fault in which the point-like image appears irregularly occurs, the point that appears irregularly is displayed like a decimal point, and the user may misrecognize a value of a displayed numerical value.

In this case, as described above, in a case where the print job without the number text is proposed as the proposal print job, the problem of erroneous recognition is less likely to occur.

### Re-Diagnosis on Image

A process after specifying a proposal print job will be described.

As described above, the CPU 11a of the server apparatus 200 specifies a proposal print job to be presented to a user of the image forming apparatus 100 based on acquired fault information.

After specifying the proposal print job, the CPU 11a of the server apparatus 200 generates information for causing the image forming apparatus 100 to actually execute the specified proposal print job.

More specifically, the CPU 11a of the server apparatus 200 generates information for causing the image forming apparatus 100 to actually execute the specified proposal print job for forming the new diagnosis image 61.

Specifically, the CPU 11a of the server apparatus 200 generates, for example, a screen illustrated in FIG. 8 (a diagram illustrating a screen generated by the CPU of the server apparatus). The CPU 11a of the server apparatus 200 further generates information for causing the user terminal 300 of the user of the image forming apparatus 100 to display the generated screen, for example.

In this example, the CPU 11a of the server apparatus 200 generates a screen for causing the image forming apparatus 100 to execute black-white printing, which is an example of the proposal print job, for forming the new diagnosis image 61.

More specifically, in this example, the CPU 11a of the server apparatus 200 includes information on the black-white printing, which is an example of the proposal print job, in the screen, and further generates a screen including a question of whether or not to perform diagnosis for the proposal print job.

More specifically, here, the CPU 11a of the server apparatus 200 generates a screen to receive an instruction from the user of the image forming apparatus 100 to start forming the diagnosis image 61 corresponding to the proposal print job.

More specifically, the CPU 11a of the server apparatus 200 generates a screen for displaying a selection item 98 of “yes” and “no,” which are selected by the user, to receive an instruction to start forming the diagnosis image 61 corresponding to the proposal print job.

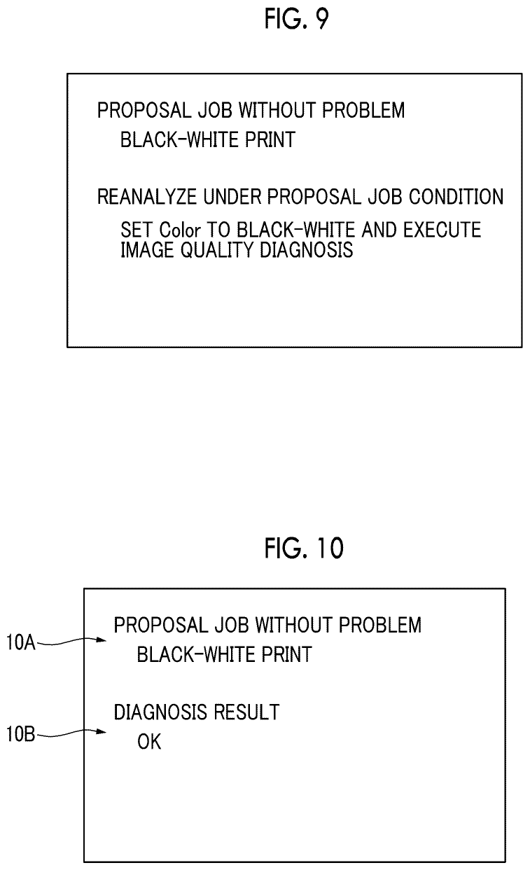

In this example, in a case where the user of the image forming apparatus 100 selects the selection item 98 of “Yes” included in the screen illustrated in FIG. 8, a screen illustrated in FIG. 9 (a screen displayed on the user terminal) is displayed on the user terminal 300 of the user.

On this screen, information indicating that the proposal print job is black-and-white printing is displayed.

Further, a procedure for forming the diagnosis image 61 with black-white printing is displayed on this screen. Specifically, on this screen, as a procedure, information indicating that a color setting is set to black-white, and then the diagnosis image 61 is to be formed is displayed.

Thereafter, in this process example, the user performs an operation on the image forming apparatus 100 (see FIG. 1) to instruct the image forming apparatus 100 to form the diagnosis image 61.

Therefore, the image forming apparatus 100 operates, and the black-white printing is executed, whereby the new diagnosis image 61 obtained under a condition of the black-white printing is formed. In other words, in this case, the new diagnosis paper CP on which the new diagnosis image 61 is formed is generated.

Here, in a case of the black-white printing, as described above, the diagnosis image 61 is formed in a state in which the photosensitive drum 101 of yellow, the photosensitive drum 101 of magenta, and the photosensitive drum 101 of cyan are separated from the intermediate transfer belt 108, and the new diagnosis paper CP is generated.

Thereafter, the user of the image forming apparatus 100 sets the generated new diagnosis paper CP on the image scanning device 130, and the new diagnosis image 61 formed on the new diagnosis paper CP is scanned.

Therefore, scan image data for the new diagnosis image 61 is generated, and the scan image data is transmitted to the server apparatus 200.

The CPU 11a of the server apparatus 200 analyzes the scan image data including the new diagnosis image 61 to acquire a diagnosis result.

In other words, in this case, the CPU 11a of the server apparatus 200 acquires the result of the diagnosis for the image obtained by the image forming apparatus 100 actually executing the proposal print job.

In this example, under a situation in which a defect occurs in the image forming unit 107C of cyan, a black-white image is formed.

In this case, the CPU 11a of the server apparatus 200 acquires information indicating that no image fault occurs as the diagnosis result obtained by analyzing the new diagnosis image 61.

Thereafter, in this process example, the CPU 11a of the server apparatus 200 generates a screen illustrated in FIG. 10 (a diagram illustrating a screen generated by the server apparatus).

As illustrated by a reference numeral 10A, information on a proposal print job is displayed on this screen. Specifically, information on black-and-white printing is displayed.

Further, as indicated by a reference numeral 10B, the screen includes a result of analysis of the new diagnosis image 61 obtained by the image forming apparatus 100 executing the proposal print job. Specifically, the information includes an indication that “OK” is obtained and that no image fault occurs.

By referring to this screen illustrated in FIG. 10, the user of the image forming apparatus 100 checks that printing can be performed without being affected by the defect of the image forming apparatus 100 at that time point for black-white printing.

### Acquisition of Print Content

In addition, the CPU 11a of the server apparatus 200 may acquire a print content provided by a user. In other words, the CPU 11a of the server apparatus 200 may acquire information on the print content provided by the user.

In this case, the CPU 11a of the server apparatus 200 generates information on an image obtained in a case where image formation based on the print content, which is based on a proposal print job, is executed by the image forming apparatus 100.

More specifically, the CPU 11a of the server apparatus 200 generates information on the presence or absence of a fault in the image, as information on the image obtained in a case where the image formation based on the print content, which is based on the proposal print job, provided by the user is executed by the image forming apparatus 100.

In other words, the CPU 11a of the server apparatus 200 generates information on an image expected to be obtained in a case where the image forming apparatus 100 forms the image based on the information on the print content and the proposal print job.

More specifically, the CPU 11a of the server apparatus 200 generates the information on the presence or absence of the fault in the image, as the information on the expected image.

More specifically, in this case, the CPU 11a of the server apparatus 200 acquires, for example, information on whether or not the print content includes a number text, based on the print content described above, which is provided from the user.

The CPU 11a of the server apparatus 200 generates information on the presence or absence of a fault in the image formed by the image forming apparatus 100, based on the information on the print content and the proposal print job.

Here, for example, a case is assumed in which a print content provided by a user includes a number text, while a proposal print job is a print job without a number text.

In this case, the CPU 11a of the server apparatus 200 generates information indicating that an image fault may occur, as information on an image formed based on the print content and the proposal print job.

In addition, for example, a case is assumed in which a print content provided by a user does not include a number text and a proposal print job is a print job without a number text.

In this case, the CPU 11a of the server apparatus 200 generates information indicating that no image fault occurs, as information on the image formed based on the print content and the proposal print job.

In addition, the CPU 11a of the server apparatus 200 acquires, for example, information on whether the print content is black-white or color, based on the print content described above, which is provided by the user.

In this case as well, the CPU 11a of the server apparatus 200 generates information on the presence or absence of a fault in the image formed by the image forming apparatus 100, based on the information on the print content and the proposal print job.

Here, for example, a case is assumed in which a print content provided by a user indicates color printing, and a proposal print job is a black-white print job.

In this case, the CPU 11a of the server apparatus 200 generates information indicating that an image fault may occur, as information on an image formed based on the print content and the proposal print job.

In addition, for example, a case is assumed in which a print content provided by a user indicates black-white printing and a proposal print job is a black-white print job.

In this case, the CPU 11a of the server apparatus 200 generates information indicating that no image fault occurs, as information on the image formed based on the print content and the proposal print job.

### Approval for Notification to User of Image Forming Apparatus 100

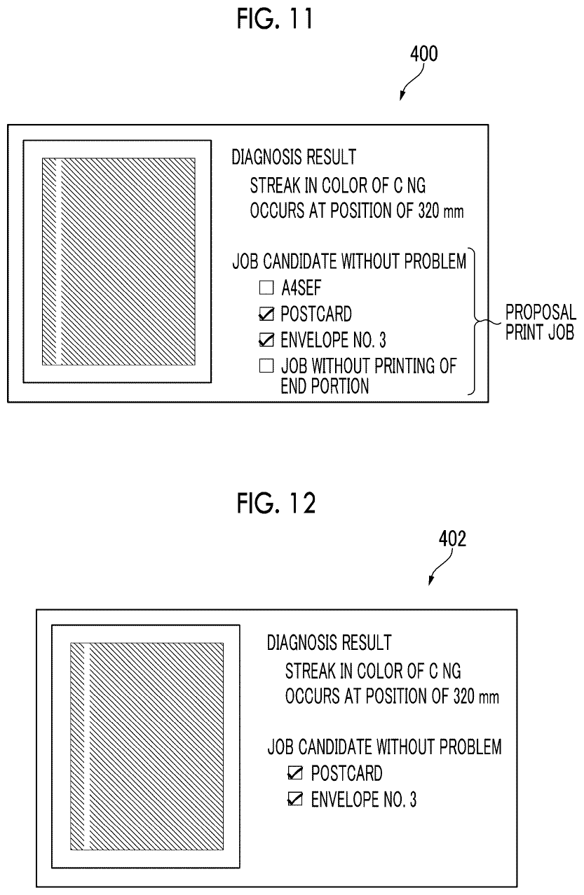

FIG. 11 is a diagram illustrating a reception screen generated by the CPU 11a of the server apparatus 200.

A process of receiving a determination on whether or not to notify a notification target person of information on the proposal print job described above, which is specified based on the fault information, from a person other than the notification target person may be performed.

In this case, as illustrated in FIG. 11, the CPU 11a of the server apparatus 200 first generates a screen 400 for receiving a determination on whether or not to notify the user who is an example of the notification target person of the information on the specified proposal print job, from the person other than the user.

Hereinafter, in the present specification, the screen 400 for reception is referred to as the “reception screen 400”.

In this manner, the CPU 11a of the server apparatus 200 generates information to be used to receive the determination on whether or not to notify the user of the information on the proposal print job from the person other than the user.

After generating the reception screen 400, the CPU 11a of the server apparatus 200 further generates information for causing a display device referred to by the person other than the user to display the reception screen 400.

As a result, the reception screen 400 is transmitted to, for example, the user terminal 300 (see FIG. 1) referred to by the person other than the user, and the reception screen 400 is displayed on the user terminal 300 referred to by the person other than the user.

In the present exemplary embodiment, the person other than the user is, for example, the maintenance person described above. Hereinafter, an example of a process in a case where the maintenance person refers to the reception screen 400 will be described.

The reception screen 400 is displayed on the user terminal 300 of the maintenance person.

In the present exemplary embodiment, the maintenance person refers to the screen illustrated in FIG. 11 to specify a proposal print job to be notified to the user of the image forming apparatus 100, who is a notification target person, among the proposal print jobs displayed on this screen, which is displayed on the user terminal 300.

In other words, in the present exemplary embodiment, the maintenance person refers to the screen illustrated in FIG. 11, further operates the user terminal 300, and specifies a print job with which a notification to the user of the image forming apparatus 100 is approved, among the proposal print jobs displayed on the screen.

FIG. 12 is a diagram illustrating a screen referred to by the user of the image forming apparatus 100.

In the present exemplary embodiment, after the maintenance person specifies the print job, information on the proposal print job specified by the maintenance person is transmitted to the server apparatus 200.

Accordingly, the CPU 11a of the server apparatus 200 generates a screen 402 illustrated in FIG. 12. More specifically, the CPU 11a of the server apparatus 200 generates the screen 402 in which the selection by the maintenance person is reflected.

More specifically, the CPU 11a of the server apparatus 200 generates the screen 402 where the proposal print job selected by the maintenance person is displayed, and a proposal print job not selected by the maintenance person is not displayed.

In the present exemplary embodiment, the generated screen 402 is displayed on, for example, the user terminal 300 (see FIG. 1) of the user, and the user of the image forming apparatus 100 is notified of the proposal print job that is selected and specified by the maintenance person.

Therefore, in the present exemplary embodiment, the proposal print job specified by the maintenance person is notified to the user. In other words, in the present exemplary embodiment, the proposal print job approved by the maintenance person is notified to the user.

Here, the CPU 11a of the server apparatus 200 generates information for notifying the notification target person of information on the proposal print job approved by the maintenance person, who is a person other than the notification target person, among the proposal print jobs initially specified by the CPU 11a of the server apparatus 200.

In a case where the process described above is performed, a probability that a fault is less likely to occur in an image formed by the image forming apparatus 100 based on the proposal print job is further increased, as compared with a case where the selection described above by the maintenance person is not performed.

### Others

The proposal print job described above is an example, and the proposal print job in a case where a printing method in the image forming apparatus 100 is a tandem printing method is described above.

In addition to the above, examples of the printing methods in the image forming apparatus 100 include a rotary method, a black-white printing method, an ink jet printing method, and the like.

The proposal print job specified based on the fault information is not limited to the proposal print job described above, and is set according to the printing method in the image forming apparatus 100.

### Supplementary Note

(((1)))

An information processing system comprising:
a processor configured to:
   acquire fault information that is information on a fault occurring in an image formed by an image forming apparatus; and
   specify a print job which is executable by the image forming apparatus and with which the fault does not occur or a degree of the fault is reduced, based on the acquired fault information.

(((2)))

The information processing system according to (((1))), wherein the processor is configured to:
specify a print job with which a member causing the fault is not to be used, based on the acquired fault information.

(((3)))

The information processing system according to (((2))),
wherein the image forming apparatus is provided with a plurality of image forming units that form images in colors different from each other, and
the processor is configured to:
   in a case where a cause specified by the acquired fault information is one of some image forming units among the plurality of provided image forming units, specify a print job with which the some image forming units are not to be used.

(((4)))

The information processing system according to (((1))), wherein the processor is configured to:
specify a print job with which a member causing the fault is to be used and a location other than a location causing the fault in the member is to be used, based on the acquired fault information.

(((5)))

The information processing system according to (((4))),
wherein the image forming apparatus transfers an image to a recording medium to form the image on the recording medium,
the image forming apparatus is provided with an image forming unit that forms the image to be transferred to the recording medium, and
the processor is configured to:
   in a case where the member causing the fault is the image forming unit, specify a print job with which a location other than a location causing the fault in the image forming unit is to be used.

(((6)))

The information processing system according to any one of (((1))) to (((5))), wherein the processor is configured to:
in a case where the fault specified by the acquired fault information is a fault in which a point-like image appears irregularly on the image formed by the image forming apparatus, specify a print job without a number text, as the print job with which the fault does not occur or the degree of the fault is reduced.

(((7))

The information processing system according to any one of (((1))) to (((6))), wherein the processor is configured to:
further acquire a result of diagnosis on an image obtained by the image forming apparatus actually executing the print job with which the fault does not occur or the degree of the fault is reduced, the fault being specified based on the acquired fault information.

(((8)))

The information processing system according to any one of (((1))) to (((7))), wherein the processor is configured to:
acquire a print content provided by a user, and
generate information on an image obtained in a case where image formation, which is based on the print job with which the fault does not occur or the degree of the fault is reduced and is based on the print content, is executed by the image forming apparatus, the fault being specified based on the acquired fault information.

(((9)))

The information processing system according to (((8))), wherein the processor is configured to:

generate information on presence or absence of the fault in the image, as the information on the image.

(((10)))

The information processing system according to any one of (((1)) to (9))), wherein the processor is configured to:
further generate information for causing a display device referred to by a person other than a notification target person to display a reception screen, which is a screen for receiving, from the person other than the notification target person, a determination on whether or not to notify the notification target person of information on the print job with which the fault does not occur or the degree of the fault is reduced, the fault being specified based on the acquired fault information.

(((11)))

The information processing system according to (((10))), wherein the processor is configured to:
notify the notification target person of information on a print job, which is approved by the person other than the notification target person via the reception screen among print jobs with which the fault does not occur or the degree of the fault is reduced, the fault being specified based on the acquired fault information.

(((12)))

A program causing a computer to execute:
a function of acquiring fault information that is information on a fault occurring in an image formed by an image forming apparatus; and
a function of specifying a print job which is executable by the image forming apparatus and with which the fault does not occur or a degree of the fault is reduced, based on the acquired fault information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
acquire fault information that is information on a fault occurring in an image formed by an image forming apparatus; and
specify a print job which is executable by the image forming apparatus and with which the fault does not occur or a degree of the fault is reduced, based on the acquired fault information.

2. The information processing system according to claim 1, wherein the processor is configured to:
specify a print job with which a member causing the fault is not to be used, based on the acquired fault information.

3. The information processing system according to claim 2,
wherein the image forming apparatus is provided with a plurality of image forming units that form images in colors different from each other, and
the processor is configured to:
in a case where a cause specified by the acquired fault information is one of some image forming units among the plurality of provided image forming units, specify a print job with which the some image forming units are not to be used.

4. The information processing system according to claim 1, wherein the processor is configured to:
specify a print job with which a member causing the fault is to be used and a location other than a location causing the fault in the member is to be used, based on the acquired fault information.

5. The information processing system according to claim 4,
wherein the image forming apparatus transfers an image to a recording medium to form the image on the recording medium,
the image forming apparatus is provided with an image forming unit that forms the image to be transferred to the recording medium, and
the processor is configured to:
in a case where the member causing the fault is the image forming unit, specify a print job with which a location other than a location causing the fault in the image forming unit is to be used.

6. The information processing system according to claim 1, wherein the processor is configured to:
in a case where the fault specified by the acquired fault information is a fault in which a point-like image appears irregularly on the image formed by the image forming apparatus, specify a print job without a number text, as the print job with which the fault does not occur or the degree of the fault is reduced.

7. The information processing system according to claim 1, wherein the processor is configured to:
further acquire a result of diagnosis on an image obtained by the image forming apparatus actually executing the print job with which the fault does not occur or the degree of the fault is reduced, the fault being specified based on the acquired fault information.

8. The information processing system according to claim 1, wherein the processor is configured to:
acquire a print content provided by a user, and
generate information on an image obtained in a case where image formation, which is based on the print job with which the fault does not occur or the degree of the fault is reduced and is based on the print content, is executed by the image forming apparatus, the fault being specified based on the acquired fault information.

9. The information processing system according to claim 8, wherein the processor is configured to:
generate information on presence or absence of the fault in the image, as the information on the image.

10. The information processing system according to claim 1, wherein the processor is configured to:
further generate information for causing a display device referred to by a person other than a notification target person to display a reception screen, which is a screen for receiving, from the person other than the notification target person, a determination on whether or not to notify the notification target person of information on the print job with which the fault does not occur or the degree of the fault is reduced, the fault being specified based on the acquired fault information.

11. The information processing system according to claim 10, wherein the processor is configured to:
notify the notification target person of information on a print job, which is approved by the person other than the notification target person via the reception screen among print jobs with which the fault does not occur or the degree of the fault is reduced, the fault being specified based on the acquired fault information.

12. A non-transitory computer readable medium storing a program causing a computer to execute:
a function of acquiring fault information that is information on a fault occurring in an image formed by an image forming apparatus; and
a function of specifying a print job which is executable by the image forming apparatus and with which the fault does not occur or a degree of the fault is reduced, based on the acquired fault information.

13. An information processing method comprising:
acquiring fault information that is information on a fault occurring in an image formed by an image forming apparatus; and
specifying a print job which is executable by the image forming apparatus and with which the fault does not occur or a degree of the fault is reduced, based on the acquired fault information.
